(19) United States
(12) Patent Application Publication
(10) Pub. No.: US 2002/0052979 A1
(43) Pub. Date: May 2, 2002

(54) Object to object communication system and method

(76) Inventors: Jochen Kappel, Vence (FR); Josef Markgraf, Goldbach (DE); Michael Meadows, Sundbyberg (SE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/823,866

(22) Filed: Mar. 31, 2001

Related U.S. Application Data
(60) Provisional application No. 60/193,422, filed on Mar. 31, 2000.

(30) Foreign Application Priority Data
Mar. 31, 2000 (DE) 00106948.3-2201

(51) Int. Cl. G06F 9/44

(52) U.S. Cl. 709/315

(57) ABSTRACT

The present invention provides a system and method for providing object to object communication. In architecture, the system includes an identifier that identifies at least two objects from a plurality of objects to communicate, and a locator that locates the at least two objects to communicate. A component framework then enables the communication of the at least two objects. The present invention can also be viewed as a method for providing object to object communication. The method operates by identifying at least two objects from a plurality of objects to communicate, and locating the at least two objects to communicate. A component framework is used to enable the communication of the at least two objects.

### CLAIM OF PRIORITY AND CROSS REFERENCE TO RELATED APPLICATIONS

This application claims the benefit of U.S. Provisional Patent Application entitled “Targys System,” filed Mar. 31, 2000 and having serial No. 60/193,422, and copending U.S. Utility Patent Application entitled, “Customer Care and Billing System,” having attorney docket no. 51207-1070, filed on Mar. 28, 2001, which also claims priority to German Patent Application No. 00106948.3-2201, entitled “Customer Care and Billing System,” filed Mar. 31, 2000, all of the foregoing of which are now pending and are incorporated herein by reference.

### FIELD OF THE INVENTION

The present invention generally relates to computers and computer software, and more particularly, to a system and method for using remote links for providing object to object communications.

### DESCRIPTION OF RELATED ART

Typically, today's computing and networking environments are complex and geographically distributed, and in the future they will be even more so. However, the complexity of assembling component systems is significantly reduced in many ways if object to object communication is not permitted and strict service based interfaces are employed. A significant shortcoming in such systems is that this forces the replication of key concepts in each component, i.e., if there are four components that use the customer class, each component will have its own implementation. Furthermore, there is the additional shortcoming that each component actually responsible for the class will have to provide a specification of the format of the flattened object service parameter(s).

Thus, a heretofore-unaddressed need exists in the industry to address the aforementioned deficiencies and inadequacies.

### SUMMARY OF THE INVENTION

The present invention provides a system and method for providing object to object communication. Briefly described, in architecture, the system of the preferred embodiment can be implemented as follows. The system includes an identifier that identifies at least two objects from a plurality of objects to communicate, and a locator that locates the at least two objects to communicate. A component framework then enables the communication of the at least two objects.

The present invention can also be viewed as providing a method for providing object to object communication. In this regard, the preferred method can be broadly summarized by the following steps. The method operates by: 1) identifying at least two objects from a plurality of objects to communicate; 2) locating the at least two objects to communicate; and 3) using the component framework to enable the communication of the at least two objects.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The accompanying drawings incorporated in and forming a part of the specification illustrate several aspects of the present invention, and together with the description, serve to explain the principles of the invention. Moreover, in the drawings, like reference numerals designate corresponding parts throughout the several views. In the drawings:

FIG. 1 is a block diagram illustrating an example of a network in which the object to object communication system and method of the present invention may be implemented.

FIG. 2 is a block diagram illustrating an example of a computer system utilizing an operating system, servers, and components that use the object to object communication system and method of the present invention.

FIG. 3 is a block diagram illustrating an example of the technical architecture of the servers utilizing the object to object communication system of the present invention, as illustrated in FIG. 2.

FIG. 4 is a block diagram illustrating an example of the interaction of the components utilizing the object to object communication system of the present invention, as illustrated in FIGS. 2, and 3.

FIG. 5 is a data flow diagram illustrating an example of the process flow of the object to object communication system 30 of the present invention.

### DETAILED DESCRIPTION OF THE PREFERRED EMBODIMENT

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

As mentioned above, the complexity of assembling component systems is significantly reduced in many ways if object to object communication is not permitted, and strict service based interfaces are employed. However, this is not efficient usage of resources. The following describes a framework design using a predominantly peer-to-peer architectural view, and thus supports object to object communication.

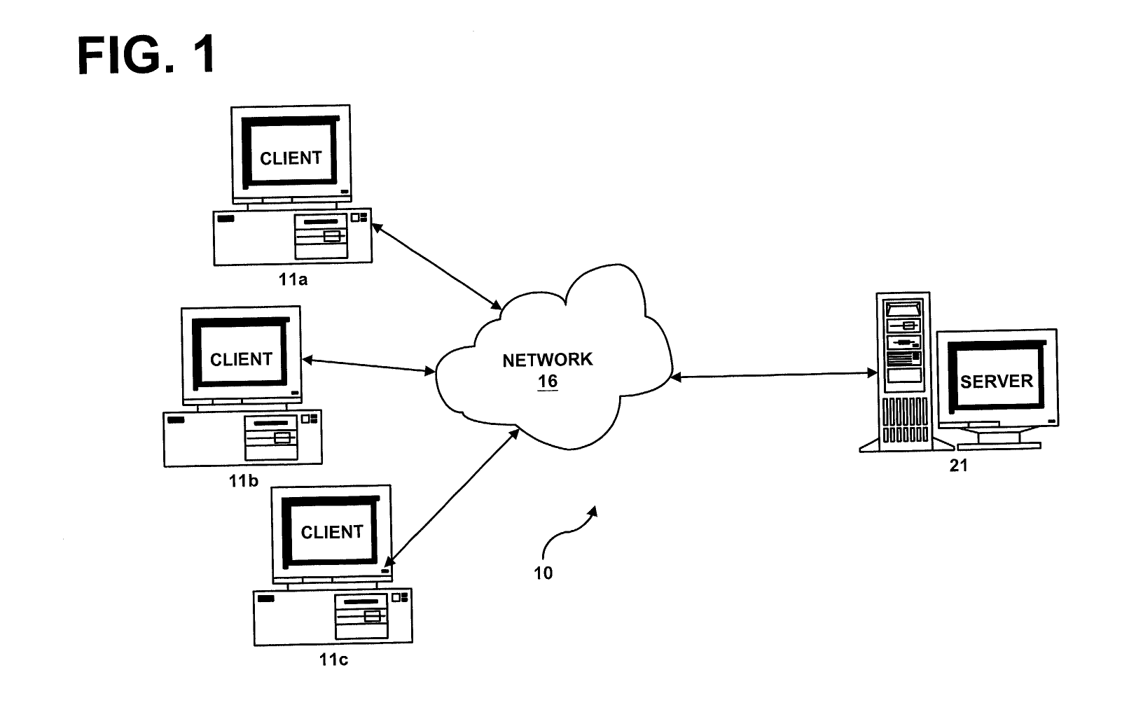

Referring now to the drawings, wherein like reference numerals designate corresponding parts throughout the drawings, FIG. 1 is a block diagram that portrays a diagram of a network that illustrates the flexibility, expandability, and platform independence in which the present object to object communication system may be implemented. Referring to FIG. 1, a series of client computers 11a, 11b, 11c are connected to a server computer 21 via a network 16. The network 16 may be, for example, but is not limited to, a dial-in network, local area network (LAN), wide area network (WAN), public switched telephone network (PSTN), Intranet, Internet, Ethernet type networks, and the like. The client computers 11a, 11b, 11c (hereinafter, 11) may be located within a LAN, WAN, PSTN, Intranet, Internet, Ethernet type networks, or the like. It should be noted that the number of client computers and server computers may differ from the number presently illustrated.

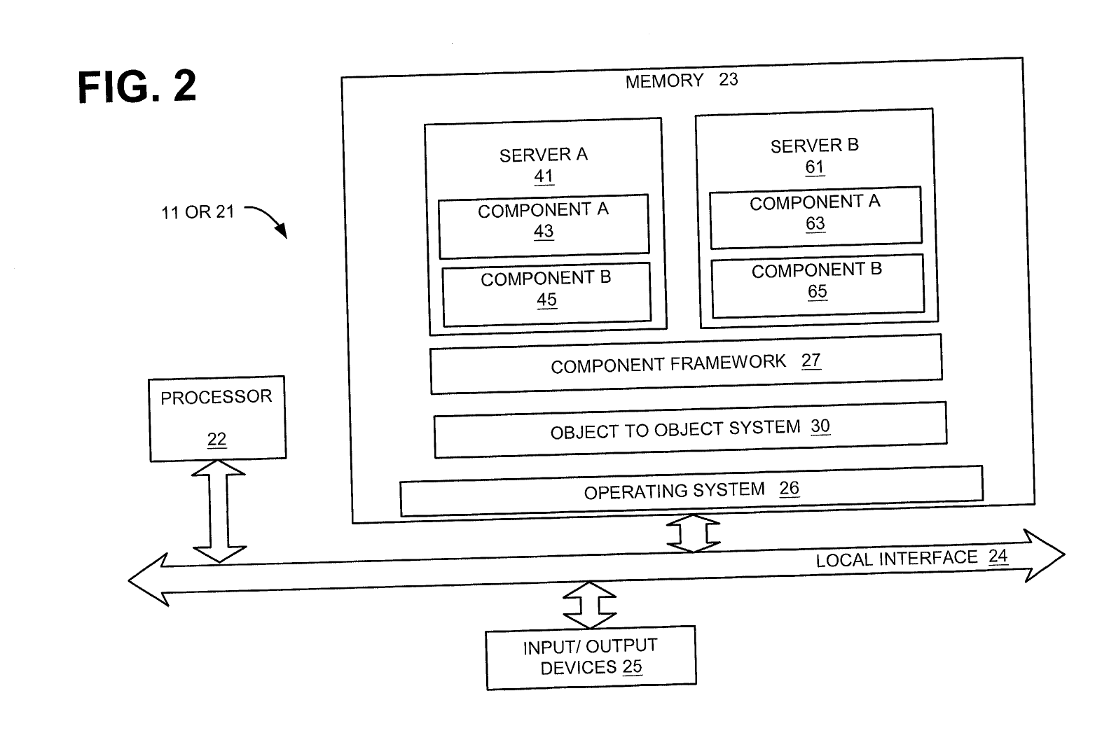

An example of a general-purpose computer that can implement the object to object communication system of the present invention is shown in FIG. 2. The object to object communication system is denoted by reference numeral 30. The object to object communication system 30 of the invention can be implemented in software (e.g., firmware), hardware, or a combination thereof. In one embodiment, the object to object communication system 30 is implemented in software, as an executable program, and is executed by a special or general purpose digital computer, such as a personal computer (PC; IBM-compatible, Apple-compatible, or otherwise), workstation, minicomputer, personal digital assistant (PDA) or mainframe computer.

Generally, in terms of hardware architecture, as shown in FIG. 2, the computer 11 or 21 includes a processor 22, memory 23, and one or more input and/or output (I/O) devices 25 (or peripherals) that are communicatively coupled via a local interface 24. The local interface 24 can be, for example but not limited to, one or more buses or other wired or wireless connections, as is known in the art. The local interface 24 may have additional elements, which are omitted for simplicity, such as controllers, buffers (caches), drivers, repeaters, and receivers, to enable communications. Further, the local interface 24 may include address, control, and/or data connections to enable appropriate communications among the aforementioned components.

The processor 22 is a hardware device for executing software that can be stored in memory 23. The processor 22 can be virtually any custom made or commercially available processor, a central processing unit (CPU) or an auxiliary processor among several processors associated with the computer 11 or 21, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 23 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 23 may incorporate electronic, magnetic, optical, and/or other types of storage media. Note that the memory 23 can have a distributed architecture, where various components are situated remote from one another, but can be accessed by the processor 22.

The software in memory 23 may include one or more separate programs, each of which comprises an ordered listing of executable instructions for implementing logical functions. In the example of FIG. 2, the software in the memory 23 includes the object to object communication system 30, component framework 27 and a suitable operating system (O/S) 26.

A non-exhaustive list of examples of suitable commercially available operating systems 26 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 26 essentially controls the execution of other computer programs, such as the object to object communication system 30, and provides scheduling, input-output control, file and data management, memory management, and communication control and related services.

The object to object communication system 30 may be a source program, executable program (object code), script, or any other entity comprising a set of instructions to be performed. When a source program, then the program is usually translated via a compiler, assembler, interpreter, or the like, which may or may not be included within the memory 23, so as to operate properly in connection with the O/S 26. Furthermore, the object to object communication system 30 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices 25 may include input devices, for example but not limited to, a keyboard, mouse, scanner, microphone, etc. Furthermore, the I/O devices 25 may also include output devices, for example but not limited to, a printer, display, etc. Finally, the I/O devices 25 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 11 or 21, is a PC, workstation, or the like, the software in the memory 23 may further include a basic input output system (BIOS) (omitted for simplicity). The BIOS is a set of essential software routines that initialize and test hardware at startup, start the O/S 26, and support the transfer of data among the hardware devices. The BIOS is stored in ROM so that the BIOS can be executed when the computer 11 or 21 is activated.

When the computer 11 or 21 is in operation, the processor 22 is configured to execute software stored within the memory 23, to communicate data to and from the memory 23, and to generally control operations of the computer 11 or 21 pursuant to the software. The object to object communication system 30 and the O/S 26 are read, in whole or in part, by the processor 22, perhaps buffered within the processor 22, and then executed.

When the object to object communication system 30 is implemented in software, as is shown in FIG. 2, it should be noted that the object to object communication system 30 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The object to object communication system 30 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the object to object communication system 30 is implemented in hardware, the object to object communication system 30 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

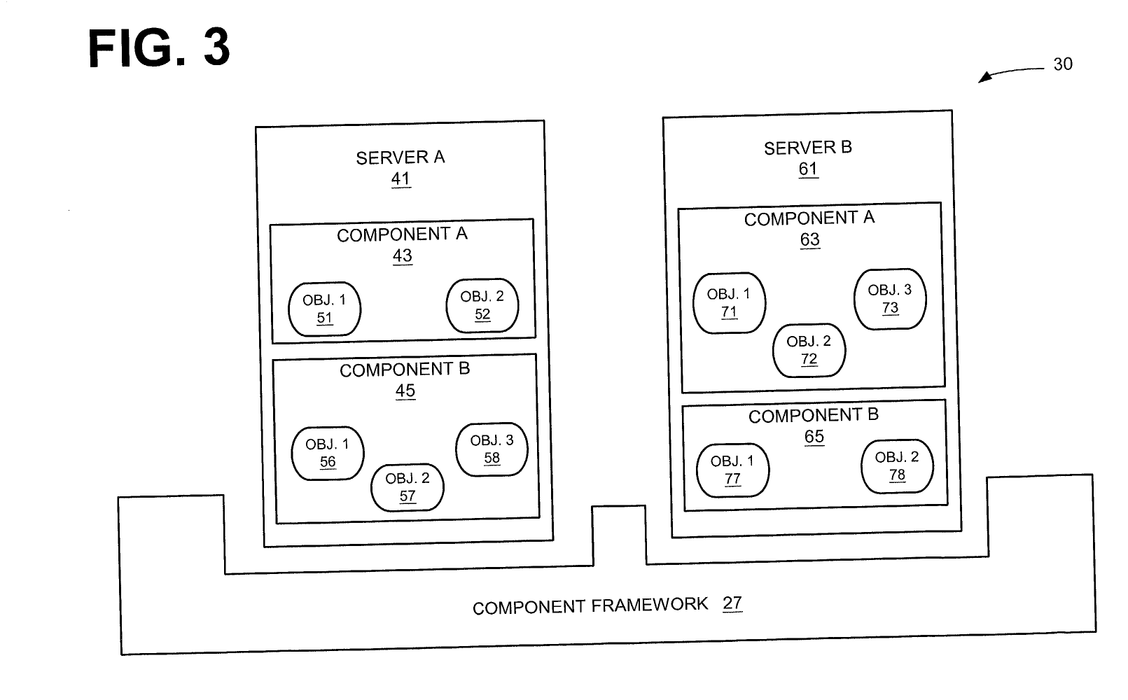

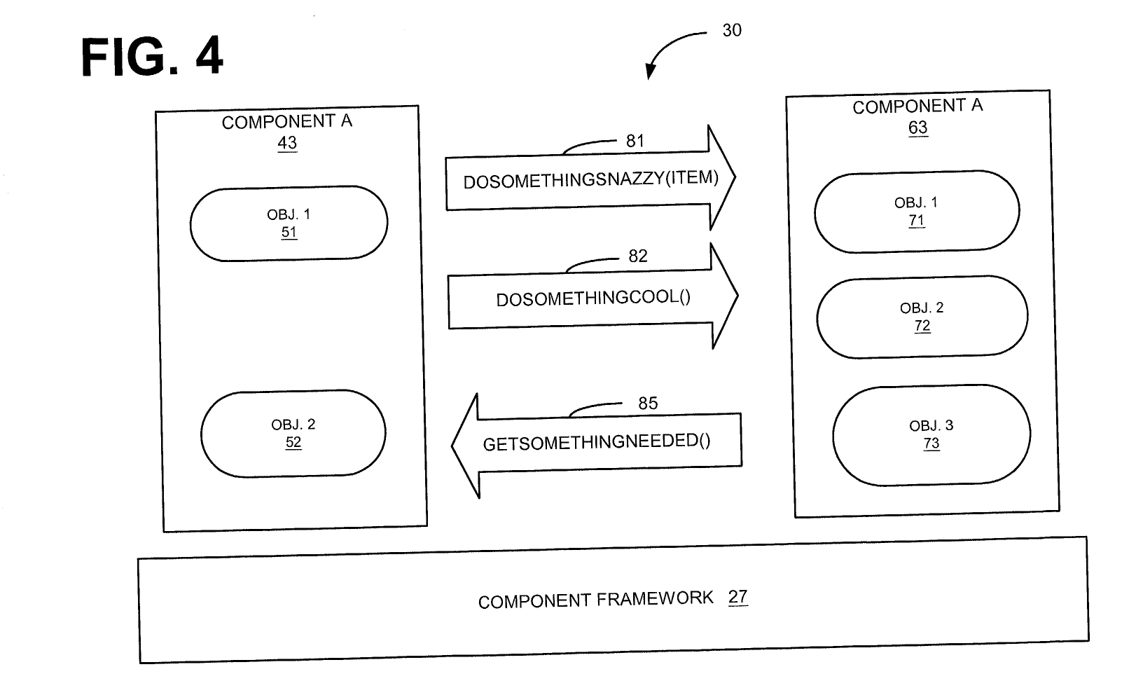

FIG. 3 is a block diagram illustrating an example of the technical architecture of the servers utilizing the object to object communication system 30 of the present invention, as illustrated in FIG. 2. Shown are the objects 51, 52 within component 43, and objects 56-58 within component 45. Both components 43 and 45 are within server 41. Also illustrated are objects 71-73 within component 63, and object 77 and 78 within component 65. Both components 63 and 65 are within server 61. Also shown is the component framework 27 that is utilized by the object to object communication system 30 to enable communications. The interaction between objects within components is herein defined in further detail with regard to FIG. 4. It should be appreciated that server 41 with components 43 and 45 and server 61 with components 63 and 65 may reside in the same local computer or on remote computers.

Illustrated in FIG. 4 is a block diagram of an example of the interaction between the objects in servers 41 and 61 (FIG. 3), utilizing the object to object communication system 30 of the present invention. As shown, the servers 41 and 61 contain a number of components that need to communicate.

In an object-based model of components, a component can be seen as a stateless object that provides a set of objects. These objects are for the most part, similar to everyday functions or procedures. While the component model described herein also employs objects, it also uses a more traditional object-oriented component model, where components publish their internal classes for use by other components. This is more in line with peer-to-peer system architectures. This allows the use of one vendor's components with components from other vendors, using an object based component architecture, but retains the benefits of the encapsulation of concepts in peer-to-peer architectures for other applications.

The component architecture of an application defines the architecture of an application built using components. Given the definition of architecture, a component architecture may then describe how these components are built, and how an application in its totality is built using components. It therefore defines the way components interact with each other, what a component is (or what roles they play), and specify how components can be assembled into systems.

The component architecture must address component life-cycle issues, describe (or provide) the technical object infrastructure for component interaction including transaction support, security support, and persistence support, describe aspects of physical deployment, address issues of system performance and scaleability, and finally include features that facilitate the development of components and complete component systems.

In order to continue describing the component architecture, it is necessary to first define what a component is, and sketch some of the key aspects of components. A component is: “a unit of composition with contractually specified interfaces and explicit context dependencies only. A software component can be deployed independently and is subject to composition by third parties.” Some of the key aspects of this definition are: (1) a component can be deployed independently (from other components); (2) a component can be used by other vendors to make custom systems; and (3) a component contains interfaces only (no state in the usual sense of a word, although a component may have properties), and places certain explicit demands on its use (within a context).

There are some (valid) implications of this definition that affect the component architecture. First, the “size” of components will be fairly large (large-grained). This follows from the fact that a component can be individually deployed (within a certain context) and, therefore, should be sufficiently self-contained. Note that this does not preclude “smaller” components—as long as it can be deployed independently from other components. For the most part, on the other hand, the self-sufficiency requirement results in rather coarse-grained components.

Second, component interfaces are primarily object-based. Given that a component has no state, the interfaces provided by a component instance provide objects and do not return information about component state (an object may provide an instance of an object with state, on the other hand). The number of objects (interfaces) provided by a component must equal that number necessary to fully publish the set of objects encapsulated within the component.

A solution using peer-to-peer objects that allows clients to directly access and use the objects within a component. Note that component object interfaces could also be used, but this would require presentation logic (not shown) to implement its own model of objects (if object technology is employed). The information in these objects would then have to be translated to a “flattened” format that a component object understands. For example, a GUI that creates a customer would use a local customer class instance to hold information, then translate the information in the instance to a format understood by a components createCustomer( ) object.

The fact that a component has no state also results in the fact that there only needs to be one instance of a component in a system, i.e. without state multiple instances of a component cannot be distinguished from one another. There may be multiple physical copies, but for a system there is only one logical instance of a component.

Components exist as logically singular units within a system, and are provided with some technical foundation for execution and communication. This is provided by a component framework 27. Components communicate with each other using objects (in another component), but also have context demands. All objects that the component relies upon that are not implemented in the component itself, can be accessed from other components on the component framework 27.

Portrayed in FIG. 4 is a strict object based architecture, i.e., there are no exported classes (or “indirect interfaces”). The use of objects that address classes must then employ some form of translation from one view to another. Note that the component framework 27 should allow the insertion of components objects from other vendors, and any definition of component (or technical implementation of) must make it possible for one to be plugged-in to another component framework. For illustration purposes only, communication with external components will be carried out via standard common object request broker architecture (CORBA) communication.

The component framework 27 is adapted to support multiple, distributed components. As such, it provides facilities for plugging-in components into a deployment environment, i.e. a server or servers, and provides the infrastructure for communication between components.

One of the main features of component framework 27 concerns containment, i.e., the component framework 27 provides the container for the execution of a component. In addition, the structure of the object design allows the easy packaging of application elements for containment purposes. The first is an implementation in software, and the second involves the structuring of the software.

The structure of the component software, because of the organization of object oriented programming (OOP) code, is as follows. A class describes a group of objects that can exist within the class. Classes are then grouped into a package, where a package is a fairly fine-grained logical domain. These packages are grouped into components using groupings that result from observance of the rules of high-cohesion and loose-coupling i.e., the packages in a component will contain classes that use each other to a significant degree while packages in separate components use each other as little as possible. In other words there is a high level of dependency among classes in packages within a component, and a low level of dependency among classes in packages in separate components. Finally, components are grouped together in servers. This grouping can be arbitrary, but some consideration should be given to the amount of traffic between components—components that communicate with each other often are best deployed in the same server.

As can be seen in FIG. 4, the component A furnishes out-services for the object 51 to interact with outside services within component A, such as for example, service 81 and 82. It is also shown that component A may import services such as service 85. Also, one way to provide third party integration of object to object communication is to utilize wrapper facades. A wrapper facade will envelope an object to component communication.

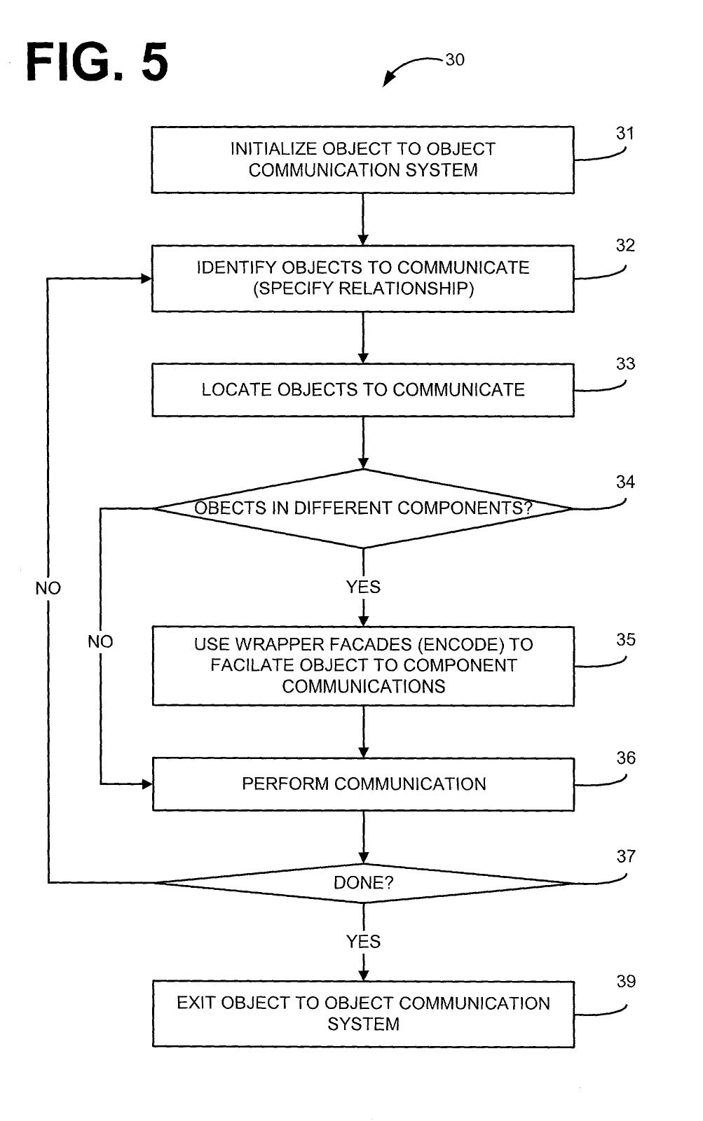

FIG. 5 is a data flow diagram illustrating an example of the process flow of the object to object communication system 30 of the present invention. The object to object communication system 30 provides the ability to process references (embedded in documents) to remote processing routines that can operate on the document.

First, the object to object communication system is initialized at step 31. Next, at step 32, the object to object communication system identifies the objects to communicate. This can be accomplished by intensifying the relationship between objects. At step 33, objects to communicate are located. This can be easily accomplished utilizing the key abstraction CCValueHolder class. The CCValueHolder class contains the behavior to find and obtain an object in an external component. The CCValueHolder class is used for all object relationships that potentially cross component boundaries (component internal relationships use another type of Valueholder). By simply specifying the relationship using this class, the framework transparently supplies all functionality to support look-up, transaction propagation, security support, and memory management across components.

At step 34, the object to object communication system 30 then determines whether the objects to communicate are in different components. If it is determined at step 34 that the objects are in different components, the object to object communication system then uses a wrapper facade to facilitate the object to component communication at step 35. Wrapper facades are an encoding of information to allow for object to component communication. However, if it is determined at step 34 that the objects are not in different components, or after performing the encoding to allow for object to component communication at step 35, the object to object communication system 30 then performs the actual object communication at step 36. At step 37, it is determined whether there are more objects to object communications to occur. If it is determined at step 37 that there are more object to object communications to occur, the object to object communication system 30 returns to repeat steps 32 to 37. However, if it is determined at step 37 that there are no more object to object communications to occur, the object to object communication system 30 then exits at step 39.

The foregoing description has been presented for purposes of illustration and description. It is not intended to be exhaustive or to limit the invention to the precise forms disclosed. Modifications or variations are possible in light of the above teachings.

The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A system for providing object to object communication, comprising:
means for identifying at least two objects from a plurality of objects to communicate;
means for locating the at least two objects to communicate; and
means for using a component framework to enable the communication of the at least two objects.

2. The system of claim 1, further comprising:
means for determining if the at least two objects are within different components.

3. The system of claim 2, further comprising:
means for using a wrapper facade to enable the communication of the at least two objects if the at least two objects are within different components.

4. The system of claim 1, further comprising:
means for determining if the at least two objects are address classes.

5. The system of claim 4, further comprising:
means for employing a translation from one view to another view if the at least two objects are address classes.

6. A method for providing object to object communication, said method comprising steps of:
identifying at least two objects from a plurality of objects to communicate;
locating the at least two objects to communicate; and
using the component framework to enable the communication of the at least two objects.

7. The method of claim 6, further comprising the step of:
determining if the at least two objects are within different components.

8. The method of claim 7, further comprising the step of:
using a wrapper facade to enable the communication of the at least two objects if the at least two objects are within different components.

9. The method of claim 6, further comprising the step of:
determining if the at least two objects are address classes.

10. The method of claim 9, further comprising the step of:
employing af translation from one view to another view if the at least two objects are address classes.

11. A computer readable medium for providing object to object communication, comprising:
logic for identifying at least two objects from a plurality of objects to communicate;
logic for locating the at least two objects to communicate; and
logic for using the component framework to enable the communication of the at least two objects.

12. The computer readable medium of claim 11, further comprising:
logic for determining if the at least two objects are within different components.

13. The computer readable medium of claim 12, further comprising:
logic for using a wrapper facade to enable the communication of the at least two objects if the at least two objects are within different components.

14. The computer readable medium of claim 11, further comprising:
logic for determining if the at least two objects are address classes.

15. The computer readable medium of claim 14, further comprising:
logic for employing a of translation from one view to another view if the at least two objects are address classes.

16. A system for providing object to object communication, comprising:
an identifier that identifies at least two objects from a plurality of objects to communicate;
a locator that locates the at least two objects to communicate; and
a component framework that enables the communication of the at least two objects.

17. The system of claim 16, wherein the locator determines if the at least two objects are within different components.

18. The system of claim 17, further comprising:
a wrapper facade that enables the communication of the at least two objects if the at least two objects are within different components

19. The system of claim 16, wherein the locator determines if the at least two objects are address classes.

20. The system of claim 19, further comprising:
a translator that translates from one view to another view if the at least two objects are address classes.
